(19) United States
(12) Patent Application Publication
(10) Pub. No.: US 2005/0042344 A1
(43) Pub. Date: Feb. 24, 2005

(54) Candies with embedded edible images

(75) Inventor: Man Chan, Kwai Chung (HK)

Correspondence Address: BURNS DOANE SWECKER & MATHIS L L P, POST OFFICE BOX 1404, ALEXANDRIA, VA, 22313-1404, US

(73) Assignee: Kimberli Limited, Kwai Chung (HK)

(21) Appl. No.: 10/643,942

(22) Filed: Aug. 20, 2003

(51) Int. Cl. A23L 1/00

(52) U.S. Cl. 426/383

(57) ABSTRACT

A candy including a substantially transparent candy layer and an edible starch sheet, said edible starch sheet being printed with an edible image with said image side underneath and facing said transparent candy layer, said edible starch sheet containing corn starch, said edible image being formed with an edible ink.

### FIELD OF THE INVENTION

The present invention relates to candies and, more particularly, to candies with embedded and edible images. More specifically, of course not solely limited thereto, this invention relates to candies with an edible sheet of printed images embedded between two transparent candy layers. This invention also relates to methods and apparatus for making substantially transparent candies and substantially transparent candies with embedded and edible images.

### BACKGROUND OF THE INVENTION

In order to attract more young consumers, candies have been made with new and interesting features to improve the appearance of candies. For examples, candies are made into various shapes of plants, flowers, cartoon figures or animals.

Traditionally, images are printed on the wrapper of candies or formed on a sticker. There were attempts to print images directly onto the surface of a candy. However, this type of printing requires the use of horizontal printing machine which are very expensive when compared to the use of a more commonly available ink-jet printer. Furthermore, it is known that candy surfaces are not a good printing medium and the printed images are generally not satisfactory.

There were also attempts to insert a generally transparent edible sheet inside a candy. In such attempts, transparent candies are cooked by “open pan” cooking methods at a relatively low temperature, for example, below 160° C., to avoid the cooked syrup from being burnt or turning brown. Cooked candies made from such methods have such a high moisture content that the shelf life is adversely affected. Also, such “open pan” cooking methods are largely manual operation. Conventional automation production apparatus or equipment for making candies are not known to be useful. As a result, known methods for making candies with an embedded edible sheet are only suitable for manual production schemes which require intensive labour and are therefore expensive and not suitable for mass production.

Hence, it is highly desirable if there can be provided improved means and methods for making substantially transparent candies with embedded edible images which alleviate the problems associates with known methods of making such candies. For example, it will be highly desirable if the edible images can be applied to a candy by ink-jet printers which are commonly available and have low operating and maintenance costs. In addition, it will be highly desirable if automated means, apparatus or equipment for making transparent candies are provided.

### OBJECT OF THE INVENTION

Accordingly, it is an object of the present invention to provide means and methods for making candies with embedded and edible images for the benefit of the general public. At a minimum, it is an object of the present invention to provide the public with a choice of candies with embedded edible images and means and methods for making same.

### SUMMARY OF THE INVENTION

According to a first aspect of the present invention, there is provided a candy including a substantially transparent candy layer and an edible starch sheet, said edible starch sheet being printed with an edible image with said image side underneath and facing said transparent candy layer, said edible starch sheet containing corn starch, said edible image being formed with an edible ink.

According to another aspect of the present invention, there is provided an edible sheet for embedding in candies, said edible sheet contains corn starch and a smoothening agent such as tapioca starch or potation starch.

According to another aspect of the present invention, there is provided a method for making substantially transparent candies, including a step of low pressure or near vacuum cooking of a syrup mixture including sugar and corn syrup.

According to another aspect of the present invention, there is provided a method of making substantially transparent candies with a substantially flat area of more than 30 cm² or with a diameter larger than 50 mm, including a step of adding lactic acid before vacuum cooking.

Preferably, said edible starch sheet further contains sodium alginate and acacia gum as thickener.

Preferably, said edible starch sheet further contains tapioca or potato starch as smoothening agent plus a thickener such as sodium alginate, acacia gum and the like.

Preferably, said edible starch sheet being adhered to said candy by an adhesive containing Arabic gum and Xanthan gum.

Preferably, said glue contains water and the ratio of Arabic gum, Xanthan gum and water being in the ratio of 30%, 5% and 65%.

Preferably, said glue further contains a mixture of gelatine and Arabic gum.

Preferably, corn starch and tapioca being in the ration of 3:1.

Preferably, said transparent candy layer includes a trace of lactic acid with a content up to 0.7%.

Preferably, said lactic acid of at about 0.03% to 0.05% by weight of the candy being added before vacuum cooking.

Preferably, said candy further including citric acid.

Preferably, said citric acid being in the region of 0.05%.

Preferably, said 0.03% to 0.05% of lactic acid being added to the candy reservoir.

Preferably, the cooking pressure is between −0.01 and −0.015 MPa.

Preferably, said syrup mixture being cooked at between 120° C. and 125° C.

Preferably, the ratio of said sugar and said corn syrup being about 45:55.

Preferably, said syrup mixture contains a mixture of lactic acid and citric acid.

Preferably, the percentage of said lactic acid and citric acid being respectively up to 0.7% and 0.05%.

### BRIEF DESCRIPTION OF THE PREFERRED EMBODIMENTS

Preferred embodiments of the present invention will be explained in further detail below by way of example and with reference to the accompanying drawings, in which:—

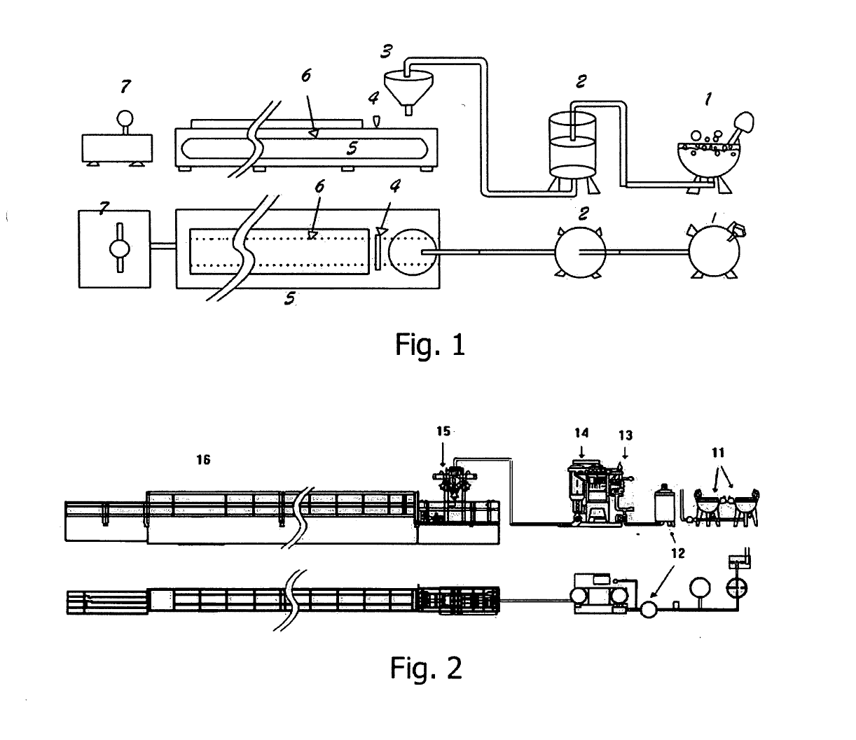

FIG. 1 shows an arrangement of apparatus for making the edible starch sheet of the present invention, and

FIG. 2 shows an arrangement of apparatus for making transparent candies of the present invention.

### DETAILED DESCRIPTION OF THE PREFERRED EMBODIMENTS

For a candy with images embedded, the images are usually sandwiched between two generally transparent candy layers in order that the embedded images can be generally visible from both sides of the candy so that a single printing is sufficient. It would be highly desirable if the printing medium includes an edible sheet which is transparent and is ink fast. An example of a suitable edible sheet which is transparent and ink fast so that images can be printed on it and visible from both sides of the edible sheet is an edible starch sheet described below.

The exemplary edible starch sheet is made from a mixture of corn starch and tapioca starch. Tapioca starch is added for additional smoothness. Alternatively or in addition, potato starch can be added to corn starch to yield the same or similar smoothness. Furthermore, sodium alginate and acacia gum are used as thickener for making the suitable starch sheet. An edible glue is used to adhere the image printed starch sheet onto the candy surface.

A suitable adhering glue includes a mixture of thickeners such as Arabic gum and Xanthan gum. Similarly, a thickener such as gelatine mixed with Arabic gum can also be a suitable glue.

Making of a Transparent Edible Starch Sheet

A method for making a transparent edible starch sheet which is suitable for printing edible images by ink-jet printers for embedding in candies will be described in the steps below and with reference to FIG. 1.
a. Corn starch and tapioca starch of the ratio 3:1 are mixed with water in a pre heated mixer 1 at a temperature of 70° C. to 80° C. A thickener solution containing about 1% sodium alginate and acacia gum at the ratio of 4:1 ratio is mixed for a period of 35 to 45 minutes.
b. A gender 2 is used to gender the starch liquid into a more smoothened mixture during the subsequent mixing process. The starch mixture is next pumped into a receiver tank 3 and transferred to a drying machine 5 by a flow controlled pipe. The drying machine consists of a stainless steel plate 6, which is about 500 mm wide and 20 m long and is being steam heated to about 100° C. The starch liquid is evenly spread on the stainless steel plate by a spreader 4 to its designed thickness.
c. The starch sheet is formed and dried when most of the water content has been removed. After this, the starch sheet is collected and placed on a cutter table 7.
d. At this point, the finished starch sheet has a preferred thickness of about 0.15 mm to 0.2 mm.
e. Next, the starch sheet is cut into a size suitable for ink-jet printing, for example, in A4 size.
f. The starch sheet is then stored under an environment with a moisture content of between 70% and 80% and at room temperature for later use.

After the starch sheet has been made and dried, images are to be printed on the pre-formed sheets of a preferred size, for example A4. Edible ink of black cyan, yellow and magenta is supplied to an ink-jet printer and pre-determined images can then be printed on the dried starch sheet by the ink-jet printer. After printing, the printed starch sheet is kept and stored under a relative humidity not exceeding 60% for about three hours so that the ink will dry and the moisture content of the starch sheet is less than 3%.

The adhesive glue for fixing the printed starch sheet on the surface of a candy is a mixture containing Arabic gum, Xanthan gum and water at the ratio of 30%, 5% and 65% respectively and the mixture is heated to a temperature of about 100° C. until complete melting of the gum in the water for subsequently adhering the starch sheet onto the candy surface.

Making of Transparent Candy Layer

Turning next to the making of the transparent candy layers with reference to FIG. 2.
a. Sugar is melted into a solution with corn syrup to form a candy liquid with sugar and corn syrup at a ratio of 45:55. The syrup is preheated at a temperature of 110° C. at the pre-melting boiler 11.
b. To obtain high mobility of the candy liquid so that a substantially transparent candy with a relatively large flat area (e.g., larger than 20 cm² or with a diameter exceeding 50 mm), an amount of lactic acid (0.03%˜0.05%) is added to the candy liquid at the candy reservoir 12 is required.
c. The candy liquid is next pumped into a pre-cooker 13 at a temperature of 120° C. to 125° C. and then transported to a vacuum cylinder tank 14 for cooking under a pressure of about −0.01 to −0.015 MPa (near vacuum).
d. The candy liquid is next pumped to the depositor 15.
e. To give a desirable sourness to the candy, a mixture of lactic acid and citric acid at a respective percentage of 0.65% and 0.05% is added to the candy liquid. The total lactic acid content is therefore about 0.7%.
f. As this candy is less sour compared with conventional deposited candy, a higher flavor content, for example, about 0.75%, can be added to make the candy more tasty.
g. The temperature at the depositing nozzle (head) is controlled to about 120° C. to 125° C. High temperature which may cause over burning of the candy to a deep yellow brown colour which should be avoided.
h. The water content and the converted sugar content of a candy made from this method are normally respectively below 3.25% and between 20% and 25%.
   Adhering the Printed Starch Sheet to the First Candy Layer

After the first transparent candy layer has been formed, the edible adhesive glue prepared above will be applied to the surface of the candy. Only a thin layer which is sufficient to paste the starch sheet is applied. The adhesive glue is then left for 15-20 seconds for drying before the starch sheet is placed onto it. The image in printed starch sheet is then placed onto the glued candy surface. To fix the starch sheet onto the glued candy surface, a plastic roller is used to press on the printed starch sheet for better adhesion to the candy surface. This intermediate candy layer is maintained at a temperature of below 25° C. and at a relative humidity of below 40% for about 4-6 hours before the second transparent layer is poured onto the first intermediate candy layer comprising the first transparent candy layer and the glued and image in printed starch sheet.

Completing the Candy by Forming the Second Transparent Candy Layer

After the intermediate candy layer comprising the first transparent candy layer and the printed image has been formed, this intermediate candy layer is placed into a mould for second or final filing in a manner which is similar to the making of the first transparent candy layer.

In order to enhance optimal feasibility of the image embedded inside the candy, the thickness of the cover layer is optimally controlled to a minimized thickness, normally not more than 5 mm.

It is noted that when acid is added into the syrup during preparation of the candy to impart the sour taste, the candy will turn yellowish which is not particularly appealing. In order to remove such a non-appetizing colour, a traces of edible blue colour is added to the candy liquid to make the candy brighter and slightly green.

When a transparent starch sheet with printed images are embedded into layers of transparent candy, the printed images are visible from both sides of the candy.

To impart better flavor to the candy and increasing its sourness, a normal method of cooking deposited candy can be used in making the primary layer. In this layer, the content of lactic acid can be set to about 1.25% by using this vacuum or vacuum cooking method. With a adding of titanium dioxide in the candy can provide a very good background for the printed image.

When this technique is applied for making lollipops, that is, a candy with stick, the first transparent candy layer is unlikely to be less than 7 mm while the stick has a diameter of about 3 mm. The stick should be placed at a level of 3 mm above the base of the candy so as to allow easy flowing and settlement of the candy syrup under the stick.

While the present invention has been explained by reference to the preferred embodiments of candies described above, it will be appreciated that the embodiments are illustrated as examples to assist understanding of the present invention and are not meant to be restrictive on the scope and spirit of the present invention. The scope of this invention should be determined from the general principles and spirit of the invention as described above. In particular, variations or modifications which are obvious or trivial to persons skilled in the art, as well as improvements made on the basis of the present invention, should be considered as falling within the scope and boundary of the present invention.

Furthermore, while the present invention has been explained by reference to making of candies, it should be appreciated that the invention can apply, whether with or without modification, to other sweets or confections without loss of generality.

1. A candy including a substantially transparent candy layer and an edible starch sheet, said edible starch sheet being printed with an edible image with said image side underneath and facing said transparent candy layer, said edible starch sheet containing corn starch, said edible image being formed with an edible ink.

2. A candy according to claim 1, wherein said edible starch sheet further contains tapioca starch or potato starch for smoothening.

3. A candy according to claim 2, wherein said edible starch sheet further contains sodium alginate and acacia gum as thickener.

4. A candy according to claim 1, wherein said edible starch sheet further contains tapioca or potato starch as smoothening agent plus a thickener such as sodium alginate, acacia gum and the like.

5. A candy according to claim 1, wherein said edible starch sheet being adhered to said candy by an adhesive containing Arabic gum and Xanthan gum.

6. A candy according to claim 5, wherein said glue contains water and the ratio of Arabic gum, Xanthan gum and water being in the ratio of 30%, 5% and 65%.

7. A candy according to claim 5, wherein said glue further contains a mixture of gelatine and Arabic gum.

8. A candy according to claim 5, wherein corn starch and tapioca being in the ration of 3:1.

9. A candy according to claim 1, wherein said transparent candy layer includes a trace of lactic acid with a content up to 0.7%.

10. A candy according to claim 9, wherein said lactic acid of at about 0.03% to 0.05% by weight of the candy being added before vacuum cooking.

11. A candy according to claim 9, further including citric acid.

12. A candy according to claim 11, wherein said citric acid being in the region of 0.05%.

13. A candy according to claim 10, wherein said 0.03% to 0.05% of lactic acid being added to the candy reservoir.

14. A method of making a substantially transparent candy or candy layer including a step of low pressure or near vacuum cooking of a syrup mixture including sugar and corn syrup and a subsequent step of automated candy depositing on to candy moulds.

15. A method according to claim 14, wherein the cooking pressure is between −0.01 and −0.015 MPa.

16. A method according to claim 15, said syrup mixture being cooked at between 120° C. and 125° C.

17. A method according to claim 14, wherein the ratio of said sugar and said corn syrup being about 45:55.

18. A method according to claim 14, wherein said syrup mixture contains a mixture of lactic acid and citric acid.

19. A method according to claim 18, wherein the percentage of said lactic acid and citric acid being up to 0.7% and 0.05%.

20. A candy made from the method of claim 14, characterized in its substantial transparency with acid and a water content of below 3.25%.

21. A method according to claim 20, characterized by a converted sugar content of between 20% and 25%.
